(19) United States
(12) Patent Application Publication
(10) Pub. No.: US 2004/0190022 A1
(43) Pub. Date: Sep. 30, 2004

(54) Color management in a prepress printing system, and profile generation for the same

(75) Inventor: Satoru Kiyohara, Kyoto (JP)

Correspondence Address: McDermott, Will & Emery, 600 13th Street, N.W., Washington, DC, 20005-3096, US

(73) Assignee: DAINIPPON SCREEN MFG, CO., LTD.

(21) Appl. No.: 10/791,822

(22) Filed: Mar. 4, 2004

(30) Foreign Application Priority Data
Mar. 25, 2003 (JP) P2003-083647

(51) Int. Cl. H04N 1/60; H04N 1/50

(52) U.S. Cl. 358/1.9; 358/504; 358/518

(57) ABSTRACT

A color chart is printed by each of multiple printers A, B, C based on the same color chart data. The printed color charts (401) are then measured using a colorimeter (110) to acquire color measurement data DA, DB, DC corresponding respectively to printers A, B, C. A profile generator (100a) then generates a profile using this color measurement data DA, DB, DC by applying an averaging operation to the color measurement data DA, DB, DC to generate average color measurement data Davg. The color measurement data DA, DB, DC and average color measurement data Davg are then displayed for evaluation by the operator, who determines whether reprinting the color chart is necessary. If reprinting is not necessary, a common profile (405) describing color reproduction by the printers A, B, C is generated based on the average color measurement data Davg. The resulting common profile is then used for color correction of image data to be used for printing in a prepress printing system comprising the printers A, B, C.

### BACKGROUND OF THE INVENTION

1. Field of Technology

The present invention relates to a color management method for managing print color in a prepress printing system, and to a method of creating a printer profile used for such color management.

2. Description of Related Art

A computer called the front-end computer is used in prepress processes to produce, edit, and layout the text, logos, images, pictures, illustrations, and other data parts composing the printed product, and thus output the edited layout data. The edited layout data is then converted by a rasterizing process to bitmapped image data defining the image to be printed. A printing plate is then produced by an imagesetter using this bitmapped image data. This printing plate is then used for printing by a printer in the printing process following this prepress platemaking process. Digital printers both generate the printing plate and print from this printing plate, and can therefore directly output hardcopy prints from the bitmapped image data supplied to the digital printer.

Any given printer generally uses a single specific color space for color management and reproduction. This means that printing the same image data on different printers can result in slightly different colors, i.e., print colors, in the printed output. Printer profiles describing the color reproduction of particular printers are therefore used to manage print colors in a process known as color management.

A typical color management process first prints a standard color chart on a printer and then measures the colors in the actually printed color chart, and based on the measured color data generates a profile describing color reproduction by that printer. This profile may be used upstream in the prepress printing processes to produce the platemaking data and printer output while managing the colors that can be reproduced by the printer based on this printer profile. A workflow including such a print color management has been proposed for producing the platemaking data and printer output.

If a prepress printing system works with multiple printer profiles because the printing company has multiple printers, however, which printer will actually be used to print each job processed by the prepress printing system may not be known until the job is actually printed. More specifically, because which printer is used to print each job depends upon the operating status of each printer, which printer will print a specific job is not known in advance. While it is possible to force printing a particular job on a specific printer, this can cause another printer to go idle while multiple jobs are queued on one printer, and thus reduces the productivity of the entire system. It is therefore difficult to manage the colors that can be reproduced as print colors in the prepress processes producing the edited layout data even though a profile is available for every printer because the printer that will be used to print the output of the prepress operation is not known at that time.

Color reproduction by any particular printer also changes over time. This means that depending upon the condition of the printer at the time the color chart was printed for calibration, the profile based on the printed color chart will be imprecise and the print colors cannot be managed appropriately.

### SUMMARY OF THE INVENTION

An object of the present invention is therefore to provide a color management method that can easily and appropriately manage print colors in the upstream operations of a prepress printing system comprising multiple printers. A further object of the invention is to provide a method of producing profiles for this color management method.

A first aspect of the present invention is a color management method for managing print colors in a prepress printing system having multiple printers. The color management method has a printing step of printing a predetermined color chart from each of the plural printers based on the same image data representing the color chart; a color measurement step of generating multiple sets of color measurement data by measuring the print colors in the prints acquired by printing the color chart; an averaging step of generating average color measurement data by averaging corresponding color measurement values in the multiple color measurement data sets; and a profile generation step of generating a common profile applied to each of the plural printers as a profile describing color reproduction by the plural printers based on the average color measurement data. This color management method then uses this common profile for color correction of image data to be printed in the prepress printing system.

A common profile is thus created based on average color measurement data acquired from multiple sets of color measurement data derived from color charts printed by a plurality of printers, and this common profile is used for color correction of image data used for printing in the prepress printing system. This enables color correcting image data used for printing and managing the colors that can be reproduced as print colors in such upstream operations as image editing and page layout without determining which printer will be used to print the work product of those upstream processes. As a result, a workflow of enhanced flexibility can be created for producing printed products and platemaking data while managing the colors that can be reproduced as print colors in upstream operations.

Such a color management method further preferably has a display step of presenting color measurement results described by the multiple sets of color measurement data generated in the color measurement step. In this case, the common profile is generated based on the average color measurement data in the profile generation step when an operator determines based on the color measurement results presented in the display step that reprinting the color chart is unnecessary.

Thus comprised, the color measurement results are displayed before the common profile is generated. This enables the operator to identify the printer producing color measurement data that deviates greatly from the color measurement data acquired from the other printers, adjust that printer accordingly, reprint the color chart and acquire new color measurement data. The common profile is then generated using this adjusted color measurement data, and a precise common profile can be produced.

Yet further preferably in the printing step the color chart is printed at multiple different times from each of the plural printers based on the same image data; and in the color measurement step the multiple sets of color measurement data are generated by measuring the printed color charts printed at the multiple different times by each of the plural printers.

Thus comprised, plural color measurement data sets are generated by measuring the colors in printed color charts printed at different times by each of the multiple printers, and the common profile is generated based on the average color measurement data calculated from the multiple color measurement data sets. This effectively cancels in the common profile any time change in the color reproduction of the printers, and thereby enables stable print color management without a large error in color reproduction.

A second aspect of the invention is a color management method for managing print colors in a prepress printing system using a profile of color reproduction by a printer. This color management method has a printing step of printing a predetermined color chart at multiple different times from a same printer based on same image data representing the color chart; a color measurement step of generating multiple sets of color measurement data by measuring print colors in multiple prints acquired by printing the color chart; an averaging step of generating average color measurement data by averaging corresponding color measurement values in the multiple color measurement data sets; and a profile generation step of generating a profile describing color reproduction by said printer based on the average color measurement data. This profile is then used for color correction of image data to be printed in the prepress printing system.

Multiple color measurement data sets are thus generated by measuring colors in the printed color charts printed at different times by the same printer, and a profile for that printer is generated based on average color measurement data calculated from the multiple color measurement data sets. This effectively cancels in the profile any time change in color reproduction by the printer, and thereby enables stable print color management without a large error in color reproduction.

A third aspect of the invention is a color management system for managing print colors in a prepress printing system having a plurality of printers. The color management system has a color measurement means for generating multiple sets of color measurement data by measuring the print colors in a plurality of prints printed by the plural printers based on same image data representing a predetermined color chart; an averaging means for generating average color measurement data by averaging corresponding color measurement values in the multiple color measurement data sets; and a profile generation means for generating a common profile applied to each of the plural printers as a profile describing color reproduction by the plural printers based on the average color measurement data. The color management system then uses this common profile for color correction of image data to be printed in the prepress printing system.

Preferably, such a color management system also has a display means for presenting the color measurement results described by the multiple sets of color measurement data generated by the color measurement means.

A fourth aspect of the invention is a color management system for managing print colors in a prepress printing system using a profile of color reproduction by a printer. This color management system has a color measurement means for generating multiple sets of color measurement data by measuring print colors in multiple prints printed at multiple different times by a same printer based on same image data representing a predetermined color chart; an averaging means for generating average color measurement data by averaging corresponding color measurement values in the multiple color measurement data sets; and a profile generation means for generating a profile describing color reproduction by said printer based on the average color measurement data. The color management system then uses this profile for color correcting image data to be printed in the prepress printing system.

A fifth aspect of the invention is a profile generator for generating a profile describing color reproduction by a printer in a prepress printing system. The profile generator has an averaging means for receiving multiple color measurement data sets acquired from multiple prints printed from same image data representing a predetermined color chart, and generating average color measurement data by averaging corresponding color measurement values in the multiple color measurement data sets; and a profile generation means for generating the profile based on the average color measurement data.

When multiple color measurement data sets acquired by measuring colors in color charts printed by multiple printers is received, a common profile is generated as a profile describing color reproduction by the multiple printers. When the multiple color measurement data sets are acquired by measuring colors in color charts printed at different times by any same printer, the effects of time change in color reproduction by the printer are cancelled in the resulting profile.

A sixth aspect of the invention is a profile generation method for generating a profile describing color reproduction of a printer in a prepress printing system. This profile generation method has an averaging step of receiving multiple color measurement data sets for multiple prints printed from same image data representing a predetermined color chart, and generating average color measurement data by averaging corresponding color measurement values in the multiple color measurement data sets; and a profile generation step of generating the profile based on the average color measurement data.

A seventh aspect of the invention is a program for generating a profile describing color reproduction of a printer in a prepress printing system. This program, when executed by a computer, causes the computer to perform an averaging step of receiving multiple color measurement data sets for multiple prints printed from same image data representing a predetermined color chart, and generating average color measurement data by averaging corresponding color measurement values in the multiple color measurement data sets; and a profile generation step of generating the profile based on the average color measurement data.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic diagram of a prepress printing system using a color management method according to a first embodiment of the present invention;

FIG. 2 is a block diagram showing the hardware configuration of a prepress data processor for producing the profiles used in the color management method according to the first embodiment;

FIG. 3 is a block diagram showing the configuration of a system implementing the color management method according to the first embodiment together with other related components;

FIG. 4 is a flow chart showing the steps of the color management method according to the first embodiment;

FIG. 5 shows an example of color measurement results displayed in the color management method according to the first embodiment;

FIG. 6 is a block diagram showing the configuration of a system implementing a color management method according to a second embodiment of the invention together with other related components; and

FIG. 7 is a block diagram showing the configuration of a system implementing a color management method according to a third embodiment of the invention together with other related components.

### DESCRIPTION OF THE PREFERRED EMBODIMENTS

Preferred embodiments of the present invention are described below with reference to the accompanying figures.

1. First Embodiment

1.1 Configuration of a Prepress Printing System

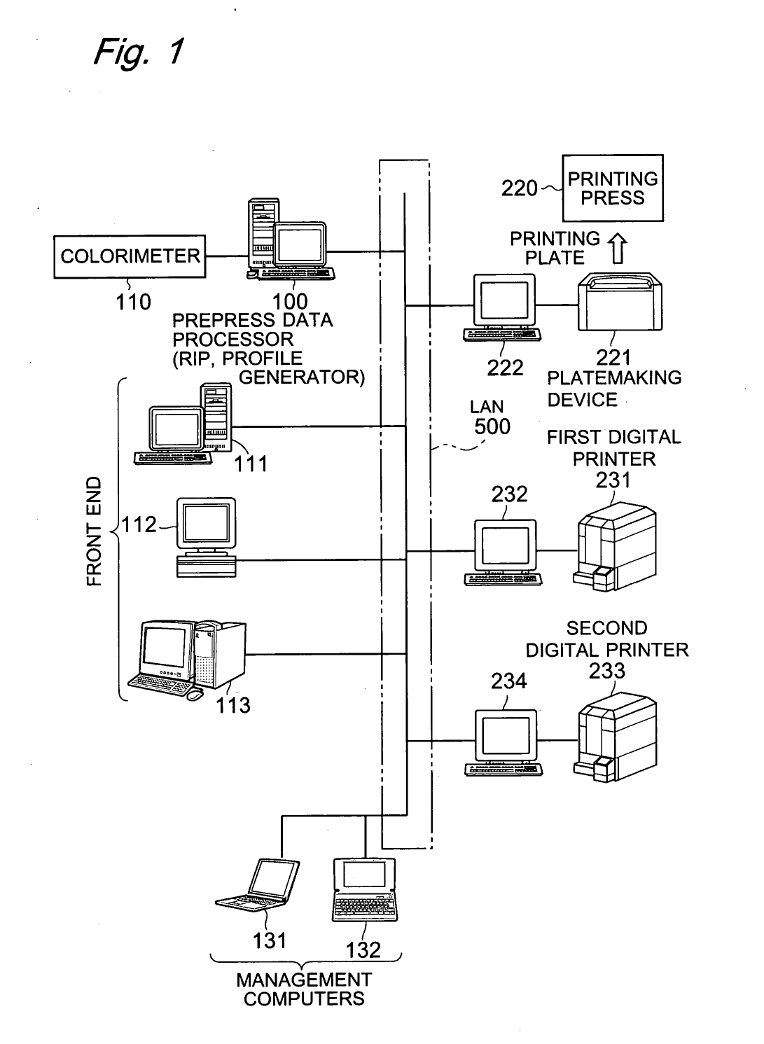

FIG. 1 is a schematic diagram of a prepress printing system using a color management method according to a first embodiment of the present invention. This prepress printing system has front-end computers 111 to 113 for editing and laying out the text, logos, pictures, illustrations, and other components composing the printed output; a plate recorder or other platemaking device 221 and a computer 222 controlling the platemaking device 221; a printing press 220 for printing using the plate prepared by the platemaking device 221; a first digital printer 231 and a control computer 232 therefor; a second digital printer 233 and a control computer 234 therefor; a prepress data processor 100 for running a process generating color profiles used for print color management, and a raster image process (RIP) generating the data used to make the printing plate; a calorimeter 110 connected to the prepress data processor 100; and management computers 131, 132 for managing delivery schedules and workflow from receiving orders to printing.

The front-end computers 111 to 113 (referred to as simply the “front end”), the control computers 222, 232, 234 for the platemaking device 221 and digital printers 231, 233, the prepress data processor 100, and the management computers 131, 132 are communicably connected via a LAN (local area network).

It will be obvious that the number of front-end computers, platemaking devices, digital printers, and other components of this prepress printing system shall not be limited to what is shown in FIG. 1. In addition, the prepress data processor 100 and control computers 222, 232, 234 for the platemaking device 221 and digital printers 231, 233 are not necessarily connected to a LAN or other communication network.

The front end of this prepress printing system generates page data describing the print data using a page description language as the result of editing and laying out the page components described above. This page data is then sent to the prepress data processor 100 or any of the controllers 222, 232, 234. The device receiving this page data, that is, prepress data processor 100 or controller 222, 232, or 234, then generates bitmapped output data by applying a rasterizing process to the page data. If this output data is generated by the prepress data processor 100, the prepress data processor 100 sends the output to controller 222, 232, or 234, the platemaking device 221 connected to the controller receiving the output data then makes a plate and the plate is used for printing by the printing press 220, or one of the digital printers 231, 233 does printing using the output data. If the output data is generated by one of the controllers 222, 232, 234, a plate is made by the platemaking device 221 connected to the controller that generated the output data and the plate is then used for printing by the printing press 220, or one of the digital printer 231 or 233 does printing using the output data.

1.2 Configuration of the Prepress Data Processor

As described above, the prepress data processor 100 functions as a raster image processor (RIP) executing a rasterizing process for producing the bitmapped data used for platemaking. In addition, the prepress data processor 100 also functions as a profile generator for generating the color profiles used for color management in this prepress printing system. The configuration of this prepress data processor 100 is described next.

It should be noted that in the prepress printing system shown in FIG. 1 the RIP and profile generator are configured in a single device 100, but they could be separate devices. Furthermore, the rasterizing process is also run by controllers 222, 232, 234, and these controllers 222, 232, 234 could therefore also function as the RIP.

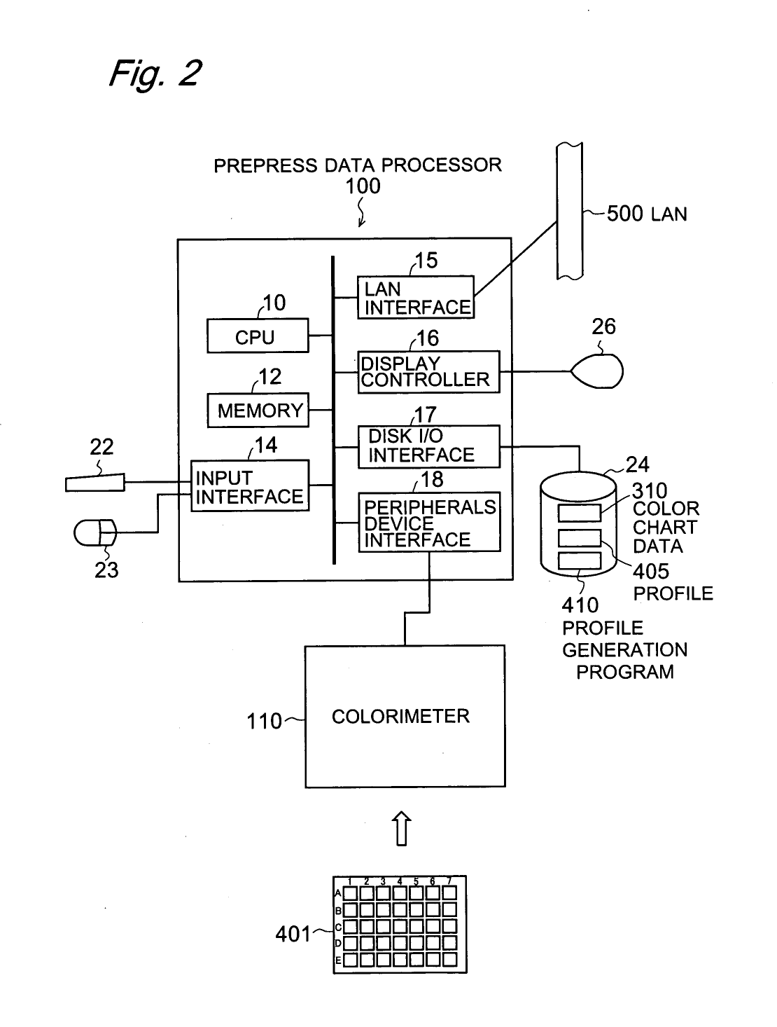

FIG. 2 is a block diagram showing the hardware configuration of the prepress data processor 100. The prepress data processor 100 is built using a personal computer or other general-purpose computer, and its hardware components thus typically include the main unit, an input device such as a keyboard 22 and mouse 23, storage such as a hard disk device 24, and a LCD, CRT, or other display device 26. The main unit includes a CPU(central processing unit) 10, a memory 12 having RAM(Random Access Memory) and ROM(Read Only Memory) for program storage and operations, an input interface 14 to which the keyboard 22, mouse 23, and other input device is connected, a LAN interface 15 for connecting the prepress data processor 100 to a LAN 500, a display controller 16 to which the display device 26 is connected, a disk I/O interface 17 to which a hard disk device 24 is connected, and a peripherals device interface 18 to which the calorimeter 110 is connected.

The colorimeter 110 is used for measuring the actual print colors in color charts 401 printed by each of the printers 220, 231, 233 based on specified standard color chart data, and generating color measurement data.

The prepress data processor 100 functions as a RIP running the rasterizing process as a result of the CPU 10 loading a specific program installed on the hard disk device 24 into memory 12 and then executing the program. This RIP is known from the literature, and further description thereof is thus omitted. As a result of the CPU 10 loading a profile generation program 410 installed to the hard disk device 24 into memory 12 and then executing the program, the prepress data processor 100 also functions as a profile generator for generating a color profile used to manage print colors in this prepress printing system.

These programs for functioning as a RIP and profile generator can be provided via a computer-readable data storage medium such as a CD-ROM disc on which the program is recorded. The user, for example, thus purchases a CD-ROM as the program storage medium, loads the disc in a CD-ROM drive (not shown in the figure), and reads and installs the program from the CD-ROM to the hard disk device 24. The program could also be received via the LAN 500 or other network and installed to the hard disk device 24. The program could also be installed to the hard disk device 24 before the prepress data processor 100 is shipped from the manufacturer.

1.3 Print Color Management in the Prepress Printing System

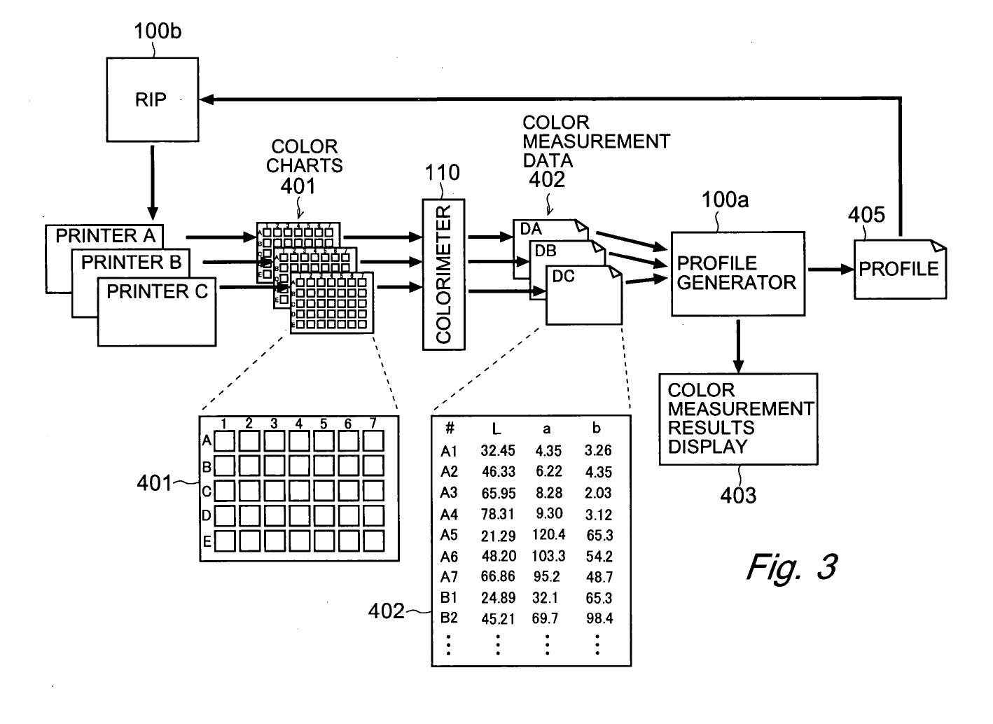

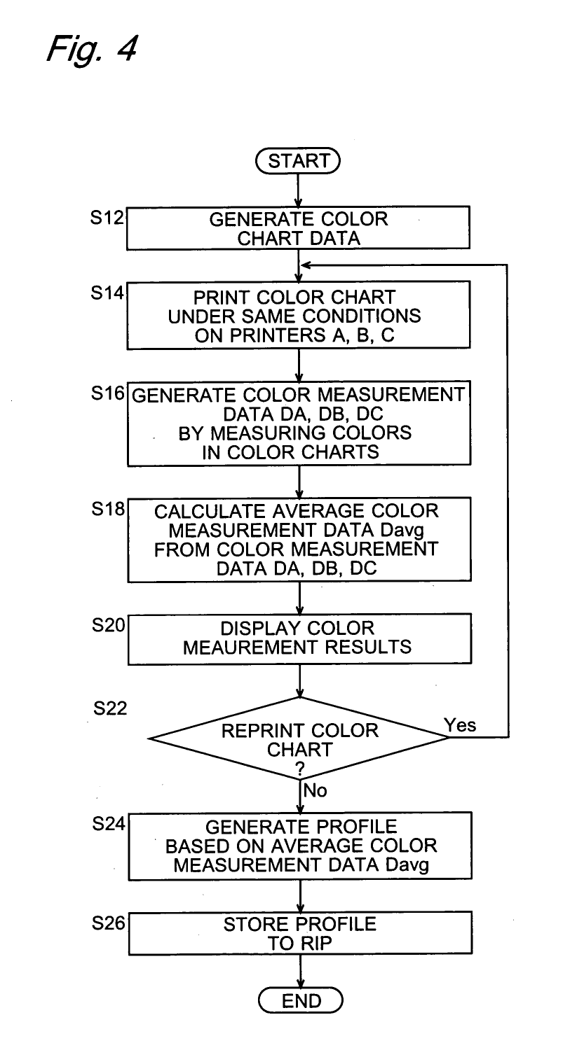

FIG. 3 is a block diagram showing a system for print color management in the prepress printing system shown in FIG. 1, that is, a system using the color management method of this embodiment of the invention (this system is referred to as a “color management system” below), and other components related thereto. FIG. 4 is a flow chart of the color management method of this embodiment. Color management by means of this embodiment of the invention is described next with reference to FIG. 3 and FIG. 4.

The prepress printing system embodying the color management method of this embodiment of the invention uses three printers A, B, C corresponding to the printers 220, 231, 233 shown in FIG. 1. To manage print colors according to color reproduction by these printers A, B, C, a color management system according to this embodiment has a calorimeter 110 and a profile generator 100a achieved by means of the prepress data processor 100. This colorimeter 110 and profile generator 100a are used to generate a profile 405 for print color management.

A color profile (also referred to simply as a profile) describing color reproduction by each printer A, B, C must be generated for print color management. This requires color chart data, that is, image data for a color chart comprising an arrangement of patches of different colors and different density. The first step in a color management method according to this embodiment of the invention is therefore to produce this color chart data (step S12), which is then stored to hard disk device 24 as the color chart data 310 for color management according to this embodiment. It will be obvious that new color chart data can be produced by the prepress data processor 100 or other part of this embodiment, but if existing color chart data is available for use that data could be stored to the hard disk device 24 for use as the color chart data 310 for color management according to this embodiment.

Printers A, B, C then print a color chart under the same conditions based on this color chart data 310 (step S14). More specifically, the prepress data processor 100 rasterizes the color chart data 310 from the hard disk device 24 to generate the output data, which is then passed through controllers 222, 232, 234 to the platemaking device 221 and digital printers 231, 233, resulting in each of the printers A, B, C (equivalent to printers 220, 231, 233) printing the same color chart under the same conditions based on the same color chart data 310. It should be noted that the “same conditions” as used here means that the reference density, paper, ink, and other printing conditions are the same on each of the printers A, B, C. This results in a color chart 401 (referred to as the “printed color chart” or just “color chart” below) based on the same color chart data 310 being outputted as the printed output of each of the three printers A, B, C. When it is necessary to differentiate among the color charts 401 outputted from the three printers A, B, C, the color charts 401 outputted from printers A, B, C are respectively referred to as color chart A, color chart B, and color chart C.

The printed color charts A, B, C are then measured by the calorimeter 110 connected to the prepress data processor 100 (profile generator 100a) (step S16). The colorimeter 110 thus outputs color measurement data DA, DB, DC for color charts A, B, C, respectively. This color measurement data DA, DB, DC is temporarily stored to the hard disk device 24 of the prepress data processor 100 (profile generator 100a). Note that when differentiating among color measurement data DA, DB, DC is unnecessary below, it is referred to as simply color measurement data 402.

As shown in FIG. 3, the color chart 401 used in this embodiment is a matrix of numerous rectangular patches, each patch uniquely identifiable using row indicia A, B, C, . . . E, and column indicia 1, 2, 3, . . . 7. The color of each patch Al, A2, . . . E7 is represented in the color measurement data 402 (DA, DB, DC) using standard L*a*b* color space values as defined by the CIE (Commission Internationale d'Eclairage).

The prepress data processor 100 then generates a profile 405 common to the three printers A, B, C (also referred to as the “common profile” below) by applying the process described in steps S18 to S24 in FIG. 4 and below based on the color measurement data 402. This process, also referred to as the “profile generation process,” is equivalent to the CPU 10 running the profile generation program 410, causing the prepress data processor 100 to function as the profile generator 100a. The CPU 10 operates as follows in the profile generation process.

First, the average color value for each corresponding patch is calculated for color measurement data DA, DB, DC, resulting in average color measurement data Davg (step S18). More specifically, if the L*, a*, b* values representing the color value of patch Yj in color measurement data DX are denoted Yj_X(L), Yj_X(a), Yj _X(b) (where X=A, B, C; Y=A to E; j=1 to 7), respectively, the L*, a*, b* values denoting the average color value of patch A1 for example are calculated using the following equations where A1_avg(L), A1_avg(a), and A1_avg(b) denote the L*, a*, b* values, respectively, for the color of patch A1 in average color measurement data Davg.

A1_avg(L)={A1_{—}A(L)+A1_{—}B(L)+A1_{—}C(L)}/3 (1)

A1_avg(a)={A1_{—}A(a)+A1_{—}B(a)+A1_{—}C(a)}/3 (2)

A1_avg(b)={A1_{—}A(b)+A1_{—}B(b)+A1_{—}C(b)}/3 (3)

The average color values are likewise calculated for the other patches A2 to E7 as follows.

A2_avg(L)={A2_{—}A(L)+A2_{—}B(L)+A2_{—}C(L)}/3 (4)

A2_avg(a)={A2_{—}A(a)+A2_{—}B(a)+A2_{—}C(a)}/3 (5)

A2_avg(b)={A2_{—}A(b)+A2_{—}B(b)+A2_{—}C(b)}/3 (6)

. . .

E7_avg(L)={E7_{—}A(L)+E7_{—}B(L)+E7_{—}C(L)}/3 (7)

E7_avg(a)={E7_{—}A(a)+E7_{—}B(a)+E7_{—}C(a)}/3 (8)

E7_avg(b)={E7_{—}A(b)+E7_{—}B(b)+E7_{—}C(b)}/3 (9)

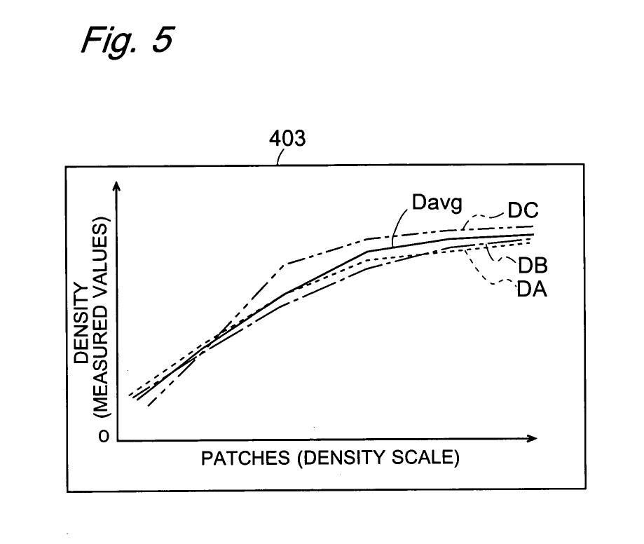

The average color measurement data Davg comprising the above computed averages is then displayed with the color measurement data DA, DB, DC on display device 26 (step S20). FIG. 5 shows an example of this display. In this example the patches are plotted according to the color density along the density scale (x-axis) and the measured density values are plotted on the y-axis. The operator then determines from this display whether to print the color chart again. The operator knows from the example shown in FIG. 5 that the density in measured color value data DC deviates greatly from the density in color value data DB and DA. By also displaying the density values of the average color measurement data Davg, these Davg values can be used as a reference to easily recognize that the density values in color data DC deviate greatly from the other color data.

In this case the operator knows that the color chart should be printed from printer C again, and appropriately operates the prepress data processor 100, for example, to print the color chart again. In this case step S22 returns yes, operation returns to step S14, and steps S14 to S22 repeat.

It should be noted that the color chart is preferably not reprinted by all printers A, B, C in this case. Instead, only the printer C that produced the color chart in which the measured color values deviate greatly from the other color measurement data DA, DB or average color measurement data Davg is controlled to reprint the color chart in order to acquire three color measurement data DA, DB, DC including the new data DC. In the example shown in FIG. 5 the middle tones of color measurement data DC deviate greatly from color measurement data DA and DB. The operator therefore makes adjustments to lower the dot gain of printer C before reprinting the color chart. By thus reprinting the color chart, all of the printers A, B, C can be calibrated to produce measured color values similar to one another, that is, to reduce the difference in the measured data.

If based on the results displayed in step S20 the operator decides that variations between color measurement data DA, DB, DC are small and it is not necessary to reprint the color chart (step S22 returns no), operation advances to step S24 based on a specific action performed by the operator. The profile generator 100a then generates a profile 405 common to the three printers A, B, C based on the average color measurement data Davg calculated in step S18 from color measurement data DA, DB, DC (step S24).

Any of various methods known from the literature can be used to generate the profile. One method, for example, calculates a matrix [M] using a least-square method so that ideal values Lab representing color chart data 310 with values in the L*a*b* color space, and calibration values Lab_avg representing the average measured color values in the same L*a*b*, are (approximately) correlated in matrix [M] as shown in the following equation.

Lab=[M]Lab_avg (10)

If Yj_r(L) is the L* value, Yj_r(a) is the a* value, and Yj_r(b) is the b* value denoting the ideal Lab value for patch Yj (Y=A to E; j=1 to 7), then

Lab=^{t}(Yj_{—}r(L), Yj_{—}r(a), Yj_{—}r(b)) (11)

Lab_avg=^{t}(Yj_avg(L), Yj_avg(a), Yj_avg(b)) (12)

where the superscripted t on the right side in equations 11 and 12 denotes transpose.

Once the common profile 405 is generated, profile generator 100a stores the common profile 405 to RIP 100b (step S26)

Because the profile generator 100a and RIP 100b are achieved by means of the same prepress data processor 100 in this embodiment, the common profile 405 can be stored to the hard disk device 24 of the prepress data processor 100. If such a configuration is not used, then the common profile 405 can be sent over a LAN, for example, to the RIP 100b.

When the RIP 100b then runs the rasterizing process to make a plate, it first uses this common profile 405 to apply color correction to the image data before running the rasterizing process, regardless of which printer A, B, C (printers 220, 231, 233) is used for printing. The designer creating the edited layout data in an upstream process can also use this common profile 405 to create, edit, and layout the components of the printed output while confirming the colors that can be reproduced by the printer.

1.4 Advantageous Effect

This embodiment of the present invention can thus apply appropriate color correction based on color reproduction by the printer before the rasterizing process in a prepress printing system having a plurality of printers, even when the printer that will actually be used for printing is unknown when color correction is applied.

Furthermore, colors that can be reproduced as print colors can be managed in upstream editing processes without specifying which printer will print the job being edited. It is therefore possible to construct a workflow of enhanced flexibility for producing printed goods and prepress data while managing in upstream processes the colors that can be reproduced as print colors.

It should be noted that because the measured color data is displayed before the common profile 405 is generated (see step S20 in FIG. 4 and FIG. 5), a accurate common profile 405 can be generated by reprinting the color chart and acquiring new color measurement data for a printer producing color data that deviates greatly from the other measured color data or average color data. The colors actually printed by a printer will vary according to the current conditions. When a color chart is reprinted by a particular printer based on the displayed color value measurements, it is therefore preferable to adjust the printer based on those measurements before reprinting the color chart, and it is possible to know what needs adjusting in the printer by displaying the color measurements.

2. Second Embodiment

In the first embodiment described above plural printers A, B, C each print a color chart based on the same color chart data 310, the print colors in the color charts are measured to acquire color measurement data DA, DB, DC, this color measurement data is then averaged to acquire average color measurement data Davg, and a common profile 405 used for managing print colors is then generated from the average color measurement data Davg.

In this second embodiment of the invention, however, a same printer prints color charts at different times based on the same color chart data 310, average color measurement data is acquired by averaging the measured color values from these multiple color charts, and a profile used to manage print colors is generated for this single printer from the average color measurement data.

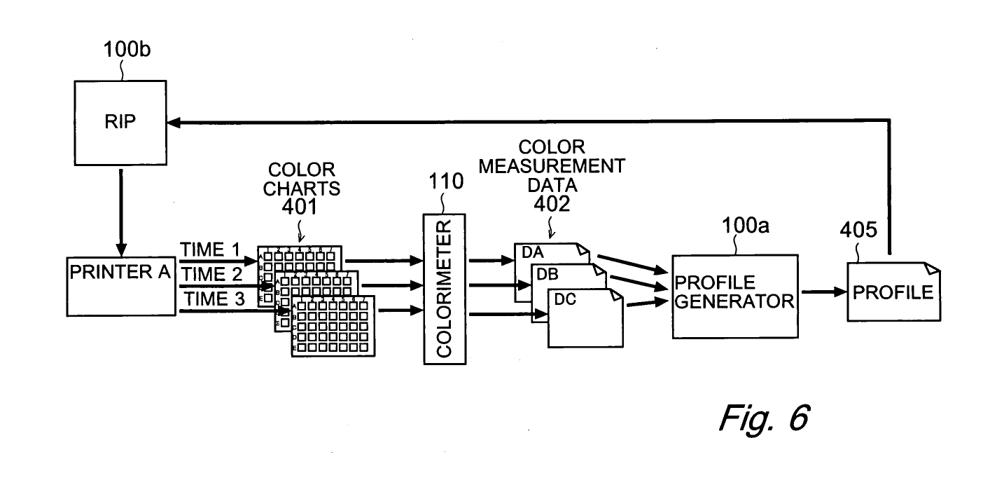

This embodiment of the invention therefore does not use the color values measured from color charts printed by multiple printers A, B, C as color measurement data DA, DB, DC. Instead, the color charts are printed from the same printer, such as printer A, at different times, such as time 1, time 2 one week after time 1, and time 3 two weeks after time 1, and the color values measured from the color charts printed at times 1, 2, and 3 are used as color measurement data DA, DB, DC. The average color measurement data Davg is then calculated from color measurement data DA, DB, DC in the same way described above, and average color measurement data Davg is used as described above to generate an average profile. The configuration of a system using the color management method of this embodiment is shown in FIG. 6.

As described above, the print colors produced by a printer have a degree of instability and tend to change over time. This embodiment of the invention generates an average profile for a specific printer based on the average color measurement data Davg acquired by averaging measurements taken over a period of time, thereby cancelling this time change in color reproduction by a given printer due to this instability and enabling stable print color management without a large error in color reproduction.

3. Third Embodiment

This third embodiment of the invention generates the average color measurement data Davg by combining the printer averaging process of the first embodiment whereby color value data is averaged from color charts printed by multiple printers A, B, C, and the time averaging process of the second embodiment whereby color value data is averaged from color charts printed by each printer at plural different times (such as times 1, 2, and 3 noted above).

Color data is thus acquired at multiple times for each printer by measuring the color charts printed at multiple different times by each printer. For example, by printing a color chart based on the same color chart data 310 from each of printers A, B, C at times 1, 2, and 3 as noted above, three sets of color measurements are acquired for each printer A, B, C. As a result, a total 3×3=9 data sets DA1-DA3, DB1-DB3, and DC1-DC3 are acquired. Average color measurement data Davg is then generated from these nine data sets DA1-DA3, DB1-DB3, and DC1-DC3 as described in the first embodiment, and profiles used for print color management are generated based on average color measurement data Davg as described in the first embodiment.

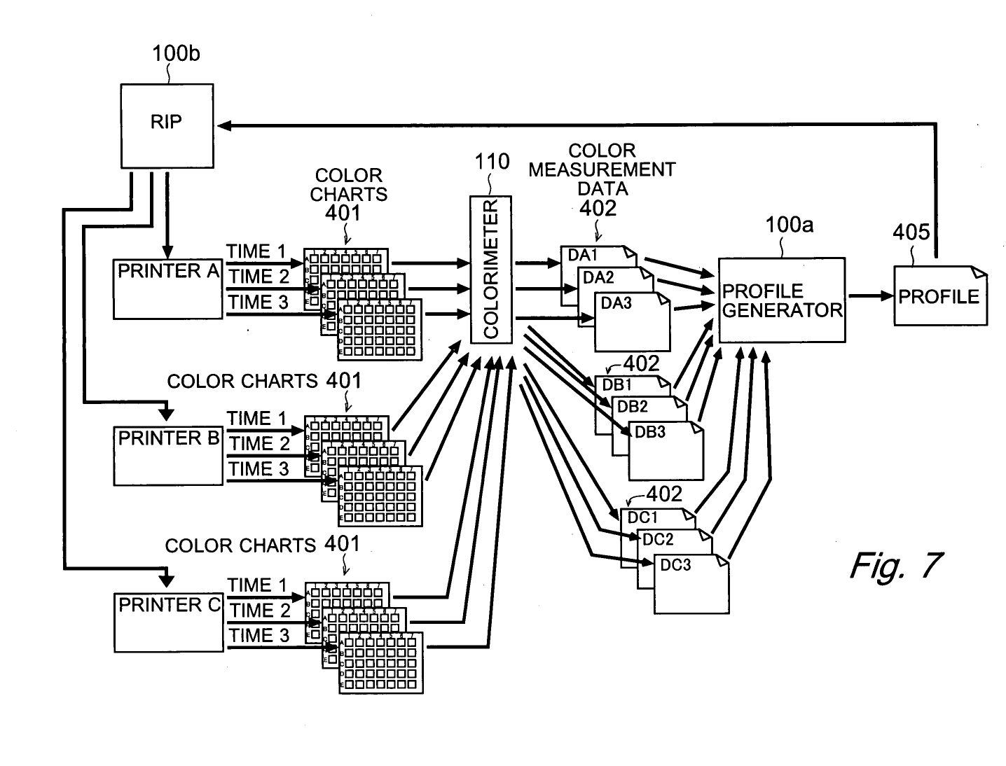

The configuration of a system using the color management method of this embodiment is shown in FIG. 7.

This embodiment of the invention thus enables flexible print color management without identifying the printer to be used for printing in upstream processes of a prepress printing system having multiple printers, cancels the time change in color reproduction by the printers, and enables stable print color management without a large error in color reproduction. More specifically, print colors can be easily and appropriately managed in the upstream processes of a prepress printing system having multiple printers.

While the invention has been described in detail, the foregoing description is in all aspects illustrative and not restrictive. It is understood that numerous other modifications and variations can be devised without departing from the scope of the invention.

This application claims priority based on Japanese patent application 2003-083647 titled “Color Management Method and Color Management System for Prepress Printing System,” filed on Mar. 25, 2003, the content of which is incorporated herein by reference.

What is claimed is:

1. A color management method for managing print colors in a prepress printing system having a plurality of printers, the color management method comprising:
a printing step of printing a predetermined color chart from each of the plural printers based on same image data representing the color chart;
a color measurement step of generating multiple sets of color measurement data by measuring the print colors in the prints acquired by printing the color chart;
an averaging step of generating average color measurement data by averaging corresponding color measurement value in the multiple color measurement data sets; and
a profile generation step of generating a common profile applied to each of the plural printers as a profile describing color reproduction by the plural printers based on the average color measurement data;
wherein the common profile is used for color correction of image data to be printed in the prepress printing system.

2. A color management method according to claim 1, further comprising a display step of presenting color measurement results described by the multiple sets of color measurement data generated in the color measurement step;
wherein in the profile generation step the common profile is generated based on the average color measurement data when an operator determines based on the color measurement results presented in the display step that reprinting the color chart is unnecessary.

3. A color management method according to claim 1, wherein in the printing step the color chart is printed at multiple different times from each of the plural printers based on the same image data; and
in the color measurement step the multiple sets of color measurement data are generated by measuring the printed color charts printed at the multiple different times by each of the plural printers.

4. A color management method for managing print colors in a prepress printing system using a profile of color reproduction by a printer, the color management method comprising:
a printing step of printing a predetermined color chart at multiple different times from a same printer based on same image data representing the color chart;
a color measurement step of generating multiple sets of color measurement data by measuring print colors in multiple prints acquired by printing the color chart;
an averaging step of generating average color measurement data by averaging corresponding color measurement values in the multiple color measurement data sets; and
a profile generation step of generating a profile describing color reproduction by said printer based on the average color measurement data;
wherein the profile is used for color correction of image data to be printed in the prepress printing system.

5. A color management system for managing print colors in a prepress printing system having a plurality of printers, comprising:
a color measurement means for generating multiple sets of color measurement data by measuring the print colors in a plurality of prints printed by the plural printers based on same image data representing a predetermined color chart;
an averaging means for generating average color measurement data by averaging corresponding color measurement values in the multiple color measurement data sets; and
a profile generation means for generating a common profile applied to each of the plural printers as a profile describing color reproduction by the plural printers based on the average color measurement data;
wherein the common profile is used for color correction of image data to be printed in the prepress printing system.

6. A color management system according to claim 5, further comprising a display means for presenting the color measurement results described by the multiple sets of color measurement data generated by the color measurement means.

7. A color management system for managing print colors in a prepress printing system using a profile of color reproduction by a printer, comprising:
a color measurement means for generating multiple sets of color measurement data by measuring print colors in multiple prints printed at multiple different times by a same printer based on same image data representing a predetermined color chart;
an averaging means for generating average color measurement data by averaging corresponding color measurement values in the multiple color measurement data sets; and
a profile generation means for generating a profile describing color reproduction by said printer based on the average color measurement data;
wherein the profile is used for color correction of image data to be printed in the prepress printing system.

8. A profile generator for generating a profile describing color reproduction by a printer in a prepress printing system, comprising:
an averaging means for receiving multiple color measurement data sets acquired from multiple prints printed from same image data representing a predetermined color chart, and generating average color measurement data by averaging corresponding color measurement values in the multiple color measurement data sets; and
a profile generation means for generating the profile based on the average color measurement data.

9. A profile generation method for generating a profile describing color reproduction of a printer in a prepress printing system, comprising:
an averaging step of receiving multiple color measurement data sets for multiple prints printed from same image data representing a predetermined color chart, and generating average color measurement data by averaging corresponding color measurement values in the multiple color measurement data sets; and
a profile generation step of generating the profile based on the average color measurement data.

10. A program for generating a profile describing color reproduction of a printer in a prepress printing system, the program, when executed by a computer, causing the computer to perform:
an averaging step of receiving multiple color measurement data sets for multiple prints printed from same image data representing a predetermined color chart, and generating average color measurement data by averaging corresponding color measurement values in the multiple color measurement data sets; and
a profile generation step of generating the profile based on the average color measurement data.
